(19) United States
(12) Patent Application Publication
(10) Pub. No.: US 2012/0115053 A1
(43) Pub. Date: May 10, 2012

(54) FUEL CELL SYSTEM

(75) Inventors: Jong-Rock CHOI, Yongin-si (KR); In-Hyuk SON, Yongin-si (KR); Jin-Goo AHN, Yongin-city (KR); Woo-Cheol SHIN, Yongin-city (KR); In-Seob SONG, Yongin-si (KR)

(73) Assignee: SAMSUNG SDI CO., LTD., Yongin-si (KR)

(21) Appl. No.: 13/162,809

(22) Filed: Jun. 17, 2011

(30) Foreign Application Priority Data
Nov. 5, 2010 (KR) 10-2010-0109847

(51) Int. Cl. H01M 8/06

(52) U.S. Cl. 429/413

(57) ABSTRACT

A fuel cell system configured to prevent fuel cell freezing is disclosed. The fuel cell system includes a fuel cell, a reformer in fluid communication with the fuel cell, the reformer including a reactor and a heat feeding unit. A moisture supplying pipe is in fluid communication with the reformer and a reformer exhausting pipe is in fluid communication with the reformer. The reformer exhaust pipe is in fluid communication with the moisture supplying pipe and configured to pass high temperature gas discharged from the reformer exhaust pipe to the moisture supplying pipe. The fuel cell system may remove moisture in the fuel cell and may also prevent the moisture from freezing by using thermal energy generated during operation of the heat feeding unit.

### CROSS-REFERENCE TO RELATED APPLICATIONS

This application claims priority to and the benefit of Korean Patent Application No. 10-2010-0109847, filed on Nov. 5, 2010, in the Korean Intellectual Property Office, the entire content of which is incorporated herein by reference.

### BACKGROUND

1. Field of the Disclosure

The present disclosure relates to a fuel cell, and more particularly, to a fuel cell system for preventing a fuel cell from freezing.

2. Description of the Related Technology

An electricity generating fuel cell stack has a structure in which several or hundreds of unit cells are laminated. Each of the unit cells includes a membrane electrode assembly (MEA) and a bipolar plate. The MEA has a structure such that an anode (called “a fuel electrode” or an “oxidizing electrode”) and a cathode (called as an “air electrode” or a “reduction electrode”) are attached to an electrolyte membrane interposed between the anode and the cathode. In this case, while hydrogen ions move to the air electrode through the electrolyte membrane as part of an electro-chemical reductive reaction with oxygen supplied to the air electrode, electric energy is generated by the movements of electrons. Additionally, reaction heat and water are produced.

However, after starting of the fuel cell and when ambient temperature drops below the freezing point of water, the water remaining in a fuel cell pipe freezes and the pipe could be broken. In addition, water freezing in the fuel cell pipe may slow or stop water feed into the fuel cell, thus preventing the fuel cell from starting. That is, when water freezes in the pipe, the fuel cell cannot start due to the frozen water and/or volume expansion of water freezing breaks or damages the MEA thus deteriorating performance of the fuel cell.

### SUMMARY OF CERTAIN INVENTIVE ASPECTS

In one aspect, a fuel cell system includes, for example, a fuel cell, a reformer in fluid communication with the fuel cell, the reformer comprising a reactor and a heat feeding unit, a fuel tank in fluid communication with the reactor, a moisture supplying pipe in fluid communication with the reactor, and a reformer exhausting pipe in fluid communication with the reformer and the moisture supplying pipe.

In some embodiments, the reformer exhausting pipe is configured to pass high temperature gas discharged from the reformer to the moisture supplying pipe. In some embodiments, the reformer exhausting pipe further includes a heat feeding unit exhaust valve configured to interrupt the high temperature gas flow to the moisture supplying pipe. In some embodiments, the moisture supplying pipe further includes a moisture supplying valve. In some embodiments, the fuel cell system further includes, for example, a controller configured to open and close the moisture supplying valve and/or the heat feeding unit exhaust valve. In some embodiments, when the heat feeding unit exhaust valve is open the fuel cell is not generating electricity. In some embodiments, the moisture supplying pipe is configured to remove moisture in the moisture supplying pipe together with the high temperature gas from the reformer.

In some embodiments, the moisture supplying pipe is configured to discharge moisture with discharge of the high temperature gas. In some embodiments, the fuel cell system further includes, for example, a pipe in fluid communication between the fuel cell and the reformer. In some embodiments, the pipe is configured to pass high temperature gas exhausted from the reformer to the fuel cell stack. In some embodiments, the moisture supplying pipe is configured to circulate the high temperature gas and the pipe fluidly connecting the reformer to the fuel cell stack is configured to remove moisture. In some embodiments, when the fuel cell is generating electricity, the heat feeding unit exhaust valve is open. In some embodiments, the moisture supplying pipe is configured to pass high temperature gas and remove moisture. In some embodiments, the moisture supplying pipe is configured to discharge moisture together with high temperature gas.

In some embodiments, the fuel cell system further includes, for example, a pipe in fluid communication between the fuel cell and the reformer. In some embodiments, the pipe is configured to pass high temperature gas discharged out of the moisture supplying pipe to the fuel cell stack. In some embodiments, when the heat feeding unit exhaust valve is open, the moisture supplying pipe supplies moisture. In some embodiments, the controller is configured to open or close at least one of the moisture supplying pipe and the heat feeding unit exhaust valve when the reformer starts reforming gas or when the reformer stops reforming gas. In some embodiments, the controller is configured to open or close at least one of the moisture supplying valve and the heat feeding unit exhaust valve for a predetermined time. In some embodiments, the controller is configured to open or close at least one of the moisture supplying valve and the heat feeding unit exhaust valve until temperature of any one of the moisture supplying pipe, the reactor, and the stack exceeds a predetermined temperature. In some embodiments, when the temperature of any one of the moisture supplying pipe, the reactor, and the stack exceeds the predetermined temperature, moisture is supplied to the reactor through the moisture supplying pipe or the heat feeding unit exhaust valve and high temperature gas is discharged from the heat feeding unit.

In another aspect, a fuel cell system is provided with a freezing prevention system for removing moisture in a fuel cell using thermal energy generated when a heat feeding unit of the fuel cell runs and for preventing the moisture from freezing.

In another aspect, a fuel cell system is provided with a freezing prevention system for improving energy efficiency using waste thermal energy when a heat feeding unit of a fuel cell runs.

### BRIEF DESCRIPTION OF THE DRAWINGS

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description of Certain Inventive Embodiments” one will understand how illustrated features serve to explain certain principles of the present disclosure.

FIG. 1 is a view illustrating a partial structure of a fuel cell system;

FIG. 2 is a block diagram illustrating one embodiment of a freezing prevention fuel cell system.

FIG. 3 is a block diagram illustrating a fuel cell system configured to process high temperature gas from a heat feeding unit during fuel cell operation.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. Since the disclosure may be modified in various ways and have various embodiments, the disclosure will be described in detail with reference to the drawings. However, it should be understood that the disclosure is not limited to a specific embodiment but includes all changes and equivalent arrangements and substitutions included in the spirit and scope of the disclosure. In the following description, if the detailed description of the already known structure and operation may confuse the subject matter of the present invention, the detailed description thereof will be omitted.

Terms “first” and “second” may be used in describing various elements but the elements are not limited to the terms. The terms are used only to distinguish an element from other elements.

Terms used in the following description are to describe specific embodiments and is not intended to limit the disclosure. The expression of singularity includes plurality meaning unless the singularity expression is explicitly different in context. It should be understood that the terms “comprising,” “having,” “including,” and “containing” are to indicate features, numbers, steps, operations, elements, parts, and/or combinations but not to exclude one or more features, numbers, steps, operations, elements, parts, and/or combinations or additional possibilities.

Since fuel of a fuel cell includes hydrogen and oxygen, the oxygen could be obtained from air, but the hydrogen does not exist in nature itself and thus the hydrogen is extracted from one or more of several fuels such as natural gas, methanol, and petroleum. The process of extracting hydrogen for use in a fuel cell is called reforming.

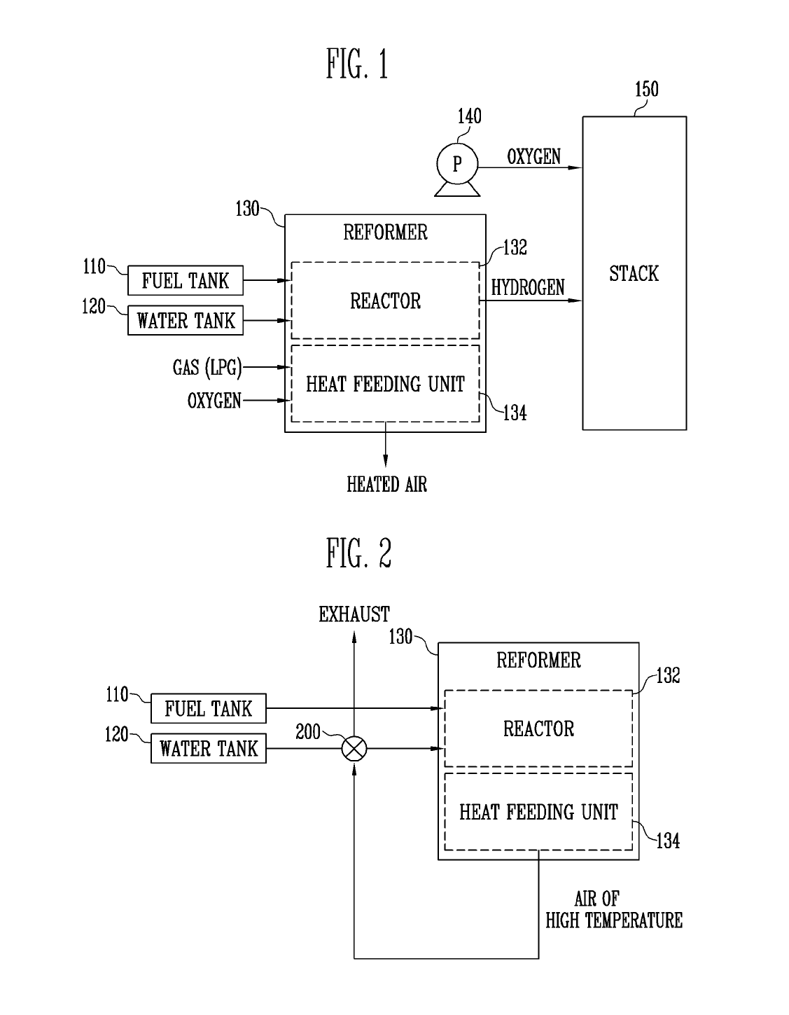

FIG. 1 is a view illustrating a fuel cell structure. Referring to FIG. 1, a fuel cell includes a fuel tank 110 filled with fuel material, a reformer 130 fluidly connected to the fuel tank 110 to produce hydrogen from the fuel material being supplied, and a stack 150 fluidly connected to an oxygen supplying pump 140, the reformer 130, and a supply pump 140. The system is configured to react hydrogen produced from the reformer 130 with oxygen supplied from the oxygen supplying pump 140 and thus generate electricity and heat. In this case, the fuel material contains hydrogen and may be gasoline or other hydrocarbons such as Liquefied Natural Gas (LNG), Liquefied Petroleum Gas (LPG), CH₃OH (methanol), etc.

In this case, the reformer 130 includes a reactor 132 and a heat feeding unit 134. When the fuel material is introduced into the reactor 132 of the reformer 130 from the fuel tank 110, water vapor is supplied from a water tank 120 to the fuel material in the reactor 132. The heat feeding unit 134 heats the reactor 132 with gas and oxygen introduced into the heat feeding unit 134 so that the reforming reaction proceeds. During this process, the reformer 130 generates heat of high temperature greater than 100 degrees Celsius.

According to the present disclosure, it is possible to introduce high temperature gas, which is generated during the operation of the reformer 130 of the fuel cell to a moisture supplying pipe. The moisture supplying pipe is configured to supply moisture (generally water vapor) from the water tank 120 to the reactor 132. The moisture supplying pipe is also configured to remove moisture remaining in the moisture supplying pipe and the reactor 132 so that moisture in the fuel cell system may be prevented from freezing.

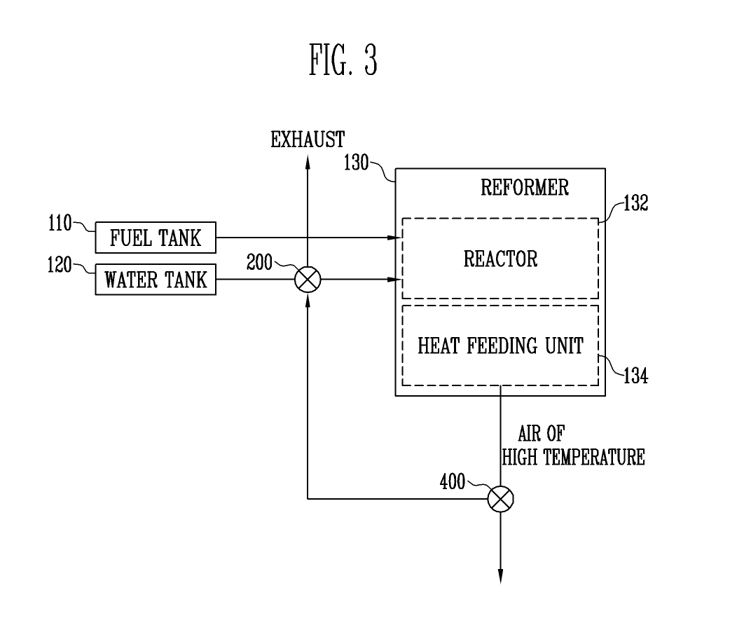

FIG. 2 is a block diagram illustrating a freezing prevention system of a fuel cell according to an embodiment of the present disclosure. The fuel cell system of FIG. 2 includes a heat feeding unit exhaust pipe configured for supplying high temperature gas heated by the heat feeding unit 134 to the moisture supplying pipe. The fuel cell system also includes a moisture supplying valve 200 configured for interrupting high temperature gas supplied from the heat feeding unit pipe. In addition, the fuel cell may further include a controller (not shown) configured to control the reformer 130, the oxygen supply pump 140, the stack 150, and the moisture supplying valve 200.

The gas of high temperature heated by the heat feeding unit 134 may be supplied to the moisture supplying pipe when the reformer 130 starts or when the reformer 130 stops. At this time, the controller (not shown) is configured to open or close the moisture supplying valve 200 such that the high temperature gas may be supplied to the moisture supplying pipe. For example, at the time when the reformer 130 starts, the controller (not shown) closes the moisture supplying valve 200 to stop the supply of moisture from the moisture supplying pipe to the reactor 132 and to allow the high temperature gas heated by the heat feeding unit 134 to be introduced into the moisture supplying pipe. Next, the high temperature gas supplied to the moisture supplying pipe may be directly exhausted after removing moisture from the pipe and preventing the pipe from freezing. The controller (not shown) may control high temperature gas to be introduced from the heat feeding unit 134 only for a predetermined time. The controller may then open the moisture supplying valve 200 after the predetermined time has elapsed so that moisture may again be supplied from the moisture supplying pipe to the reactor 132.

In addition, the high temperature gas may flow through the moisture supplying pipe and remove moisture remaining in the moisture supplying pipe when the reformer 130 is stopped. The high temperature gas may also flow through the moisture supplying pipe and be introduced into the reformer 130 when the reformer 130 starts.

FIG. 3 is a block diagram illustrating a partial fuel cell system configured to process high temperature gas from a heat feeding unit during fuel cell operation. Referring to FIG. 3, a freezing prevention fuel cell system includes a heat feeding unit exhaust valve 400 configured for interrupting or allowing discharge of high temperature gas heated by the heat feeding unit 134.

In a case where high temperature gas circulates inside the fuel cell from the heat feeding unit 134 when the reformer 130 starts or stops, the controller (not shown) is configured to control the heat feeding unit exhaust valve 400 to interrupt flow of the high temperature gas heated and then discharged by the heat feeding unit 134 to the moisture supplying pipe.

If the high temperature gas is supplied to the moisture supplying pipe only for a predetermined time, after the predetermined time has been elapsed, the controller directs the heat feeding unit exhaust valve 400 to interrupt the high temperature gas from moving to the moisture supplying pipe and thus allows the high temperature gas to be discharged.

The controller may be configured to control the high temperature gas circulation according to an inside fuel cell temperature. For example, the controller (not shown) may control the heat feeding unit 134, the moisture supplying valve 200, and the heat feeding unit exhaust valve 400 such that the high temperature gas circulates until temperature of the moisture supplying pipe, the reactor 132 or the stack 150 exceeds a predetermined temperature. In this case, when the temperature of the moisture supplying pipe, the reactor 132, or the stack 150 exceeds the predetermined temperature, the controller directs the moisture supplying valve 200 such that moisture is supplied to the reactor 132 through the moisture supplying pipe and the heat feeding unit exhaust valve 400 and the high temperature gas heated by the heat feeding unit 134 is discharged out or to other devices. The high temperature gas may flow through the moisture supplying pipe via the heat feeding unit exhaust valve 400 to prevent water remaining in the pipe from freezing. The high temperature gas may be re-introduced into the reformer 130, and may be discharged with moisture through the heat feeding unit exhaust valve 400 or the moisture supplying valve 200.

In addition, the heat feeding unit exhaust valve 400 may be opened after the reforming 130 stops. However, when the reformer 130 starts, high temperature gas flows into the moisture supplying pipe before the moisture is supplied from the water tank 120 so that the moisture supplying pipe may be heated.

Meanwhile, the high temperature gas may be exhausted out of the reformer via a pipe fluidly connecting the reformer with the fuel cell stack. In this case, moisture in the pipe connecting the reformer with the stack may be removed or may be prevented from freezing. That is, the high temperature gas heated by the heat feeding unit 134 is introduced into the hydrogen supplying pipe for supplying hydrogen extracted by the reactor 132 to the stack 150. At this time, the heat feeding unit 134 and the hydrogen supplying pipe are fluidly connected to each other by the heat feeding unit exhaust pipe. The fuel cell may further include a hydrogen pipe valve configured for allowing or interrupting hydrogen from being supplied from the reactor 132 and a heat feeding unit exhaust valve (not shown) configured for allowing or interrupting the high temperature gas from being discharged out from the heat feeding unit 134.

The high temperature gas heated by the heat feeding unit 134, as described above, may be circulated through a pipe between the water tank 120 and the reformer 130 or between the reformer 130 and the stack 150 as described FIG. 1 using the existing moisture supplying pipe or a hydrogen supplying pipe to separately manage the high temperature gas heated by the heat feeding unit 134.

While the present invention has been described in connection with certain exemplary embodiments, it will be appreciated by those skilled in the art that various modifications and changes may be made without departing from the scope of the present disclosure. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A fuel cell system, comprising:
a fuel cell;
a reformer in fluid communication with the fuel cell, the reformer comprising a reactor and a heat feeding unit;
a fuel tank in fluid communication with the reactor;
a moisture supplying pipe in fluid communication with the reactor; and
a reformer exhausting pipe in fluid communication with the reformer and the moisture supplying pipe,
wherein the reformer exhausting pipe is configured to pass high temperature gas discharged from the reformer to the moisture supplying pipe.

2. The fuel cell system of claim 1, wherein the reformer exhausting pipe further comprises a heat feeding unit exhaust valve configured to interrupt the high temperature gas flow to the moisture supplying pipe.

3. The fuel cell system of claim 2, wherein the moisture supplying pipe further comprises a moisture supplying valve.

4. The fuel cell system of claim 3 further comprising a controller configured to open and close the moisture supplying valve and/or the heat feeding unit exhaust valve.

5. The fuel cell system of claim 2, wherein the heat feeding unit exhaust valve is open when the fuel cell is not generating electricity.

6. The fuel cell system of claim 5, wherein the moisture supplying pipe is configured to remove moisture in the moisture supplying pipe together with the high temperature gas.

7. The fuel cell system of claim 5, wherein the moisture supplying pipe is configured to discharge moisture with discharge of the high temperature gas.

8. The fuel cell system of claim 6 further comprising a pipe in fluid communication between the fuel cell and the reformer, wherein the pipe is configured to pass high temperature gas exhausted from the reformer to the fuel cell stack.

9. The fuel cell system of claim 6, wherein the moisture supplying pipe is configured to circulate the high temperature gas and the pipe fluidly connecting the reformer to the fuel cell stack is configured to remove moisture.

10. The fuel cell system of claim 2, wherein when the fuel cell is generating electricity, the heat feeding unit exhaust valve is open.

11. The fuel cell system of claim 10, wherein the moisture supplying pipe is configured to pass high temperature gas and remove moisture.

12. The fuel cell system of claim 10, wherein the moisture supplying pipe is configured to discharge moisture together using high temperature gas.

13. The fuel cell system of claim 11 further comprising a pipe in fluid communication between the fuel cell and the reformer, wherein the pipe is configured to pass high temperature gas discharged out of the moisture supplying pipe to the fuel cell stack.

14. The fuel cell system of claim 10, wherein when the heat feeding unit exhaust valve is open, the moisture supplying pipe supplies moisture.

15. The fuel cell system of claim 4, wherein the controller is configured to open or close at least one of the moisture supplying pipe and the heat feeding unit exhaust valve when the reformer starts reforming gas or when the reformer stops reforming gas.

16. The fuel cell system of claim 15, wherein the controller is configured to open or close at least one of the moisture supplying valve and the heat feeding unit exhaust valve for a predetermined time.

17. The fuel cell system of claim 15, wherein the controller is configured to open or close at least one of the moisture supplying valve and the heat feeding unit exhaust valve until temperature of any one of the moisture supplying pipe, the reactor, and the stack exceeds a predetermined temperature.

18. The fuel cell system of claim 17, wherein, when the temperature of any one of the moisture supplying pipe, the reactor, and the stack exceeds the predetermined temperature, moisture is supplied to the reactor through the moisture supplying pipe or the heat feeding unit exhaust valve and high temperature gas is discharged from the heat feeding unit.
